(19) United States
(12) Patent Application Publication
(10) Pub. No.: US 2005/0082427 A1
(43) Pub. Date: Apr. 21, 2005

(54) Aircraft landing gear actuation system

(76) Inventor: Taehun Seung, Scheidegg (DE)

Correspondence Address: DILWORTH & BARRESE, LLP, 333 EARLE OVINGTON BLVD., UNIONDALE, NY, 11553, US

(21) Appl. No.: 10/886,818

(22) Filed: Jul. 8, 2004

(30) Foreign Application Priority Data
Jul. 8, 2003 (DE) 103 30 805.9

(51) Int. Cl. B64C 25/10

(52) U.S. Cl. 244/102 R

(57) ABSTRACT

The invention relates to an aircraft landing actuation system, comprising a door actuation device to open and close a landing gear door, and a landing gear actuation device to retract and lower the landing gear. According to the invention, the landing gear actuation system is distinguished by the fact that at least the landing gear actuation device has an electric actuator motor.

The invention relates to an aircraft landing actuation system, comprising a door actuation device to open and close a landing gear door, and a landing gear actuation device to retract and lower the landing gear.

Landing gear actuation systems on aircraft conventionally function hydraulically and are fed by a central hydraulic supply system. For safety reasons, aircraft regularly have two or three central hydraulic systems to which the landing gear actuation system can be connected. This central hydraulic system is continually driven by the engines so as to supply the various systems of the aircraft. With regard to the landing gear actuation system, this approach is relatively inefficient since the hydraulic system must also provide the pressure for the landing gear actuation system continually despite the fact that this system is generally operated only twice during a flight cycle, that is, before landing and after take-off. Another disadvantage of conventional landing gear actuation systems is the multiplicity of valves employed through which the hydraulic fluid delivered by the central hydraulic supply system is applied to the various actuators of the landing gear actuation system. The number of possible sources of defects or failures is correspondingly high.

The goal of the invention is to create an improved landing aircraft gear actuation system of the species referenced in the introduction which avoids the disadvantages of the prior art and modifies this prior art in an advantageous manner. Preferably, the purpose is to create a simplified, energy-efficient landing gear actuation system whose susceptibility to failures is diminished.

According to the invention, this goal is achieved by an aircraft landing gear actuation system as described in Claim 1. Advantageous embodiments of the invention are presented in the subordinate claims.

According to the invention, at least the landing gear actuation system has an electrical actuator. Electrical actuation of the landing gear allows for energy-efficient operation since the actuator motor is actuated only when landing gear actuation is required. During the remainder of the aircraft's operation, that is, during the flight, the actuator motor can be in a non-operating state. In addition, control of the landing gear actuation system is simplified since the electric actuator motor is controllable by simple electrical means. Preferably, not only the landing gear actuation device but also the door actuation device, and possibly additional actuation devices, such as the landing gear steering device for the front landing gear, are able to be actuated by an electric actuator motor.

In a modification of the invention, the landing gear device, the door actuation device, and possibly additional actuators such as the landing gear steering device, are each of an electrohydraulic design. The electric actuator motor drives a hydraulic pump by which the actuating cylinders of the landing gear actuation device, the door actuation device, and the landing gear steering device are able to be actuated. In other words, the various actuation devices of the landing gear actuation system are advantageously able to be actuated by a common electric actuator motor. To provide redundancy, a second electric actuator motor may be provided, as required—however, it is not necessary for each actuation device to have its own electric actuator motor.

In principle, it is also possible for the driving motion of the electric actuator motor to be transmitted to the actuation device by another means, specifically, mechanically through a gear system. Conversion of the driving motion of the electric actuator motor into hydraulic power has advantages in terms of simple design. In addition, existing proven components may be used for the actuation device.

In a modification of the invention, the electric actuator motor is provided exclusively for purposes of landing gear actuation. In other words, it is not used to generate any additional system power to drive other aircraft components. Specifically, no hydraulic power from the hydraulic pump driven by the electric actuator motor is tapped to actuate additional aircraft components. By using a separate actuator for the landing gear actuation system, this actuator can be designed specifically for the landing gear actuation system and be in an non-operating state during the preponderance of the time of the flight.

In a modification of the invention, the front landing gear and main landing gear have separate electric actuator motors and separate hydraulic pumps driven by the respective actuator motors. In other words, the front landing gear and main landing gear are each driven autonomously. This approach has the great advantage that no long hydraulic lines have to be installed within the aircraft. The source of hydraulic pressure is situated locally. First, this approach saves the weight of the long hydraulic lines. Secondly, there is no line loss, with the result that it is easier to dimension the actuator motors and pumps. For the right and left main landing gear, a common electrical actuator can be provided, as well as a hydraulic pump driven by this actuator. Preferably, it is also possible for the right main landing gear and left main landing gear to have separate actuators and associated hydraulic pumps.

Control of the landing gear actuation system can be designed using a variety of principles. In a first preferred embodiment, the landing gear actuation system is controlled by directly controlling the electric actuator motor and the pump driven thereby. The speed of the actuator motor can be controlled so as to define the travel of each actuation device. For example, a reciprocating pump may be utilized such that a predetermined speed corresponds to a specific hydraulic fluid delivery which in turn determines the travel of the corresponding actuator. By controlling the direction of motion for the actuator motor, or of the driven hydraulic pump, the direction of the operating motion of each actuator can be controlled.

In an alternative, second preferred embodiment of the invention, a control device can be provided which controls the actuation of the landing gear actuation device, door actuation device, or landing gear steering device whereby the actuator motor runs at an essentially constant rate in an approach in which said control device controls the delivery volume from the constantly running hydraulic pump fed to the hydraulic circuit, for example through a flow control valve. In this case, it is possible to use a simple asynchronous motor as the actuator motor. The design of the drive unit is thus simplified.

In order to achieve especially efficient operation, the various actuation devices of the landing gear actuation system are never actuated simultaneously but always sequentially. This approach has the advantage that the hydraulic pump, and motor driving this pump, can thus be of a lighter design. It is only necessary to design them to actuate the actuation device using the most power, but not for the total power requirement of multiple actuation devices. This saves weight. In terms of the engineering of the devices, the sequential actuation is preferably achieved by making the door actuation device, and possibly the landing gear steering device, connectable through a valve system with the same hydraulic supply source, whereby the valve system is designed such that at all times a maximum of only one actuation device is connectable to the hydraulic supply source. In principle, the hydraulic supply system of an aircraft can be used as the hydraulic supply source. The preferred approach, however, is to provide a local hydraulic supply system of the type described above having an electric motor, and a hydraulic pump driven thereby, which are specifically provided for the landing gear actuation system. The valve system, which prevents simultaneous actuation of the actuation devices, is preferably composed of serially connected control valves which on the outlet side always open only one outlet channel or outlet channel pair composed of a forward and return feed. The control valves allow the inlet-side hydraulic pressure to be branched to various actuation devices. However, since on the outlet side of the control valves only one branch is open in each case, each of the other branches and connected actuation devices are shut.

In a modification of the invention, the connection lines of the landing gear actuation device and door actuation device are joined at a common control valve: which is connectable on the inlet side with the hydraulic supply system; which connects, in a first position, the connection lines of the landing gear actuation device to the main hydraulic supply system while simultaneously interrupting the connection lines of the door actuation device from the hydraulic supply system; and which interrupts, in a second position, the connection lines of the landing gear actuation device from the hydraulic supply system but connects the connection lines of the door actuation device to the hydraulic supply system. Depending on the position of this control valve, in other words, either the landing gear actuation device or door actuation device are able to be actuated, but not both simultaneously.

In a modification of the invention, the control valve has a third position in which the connection lines both of the landing gear actuation device and door actuation device are disconnected from the hydraulic supply system, and the inlet-side lines of the hydraulic supply system are short-circuited, preferably, through a filament choke. Hydraulic fluid can be circulated through this, in order, for example, to circulate and heat up the hydraulic fluid when the temperature of the hydraulic fluid falls excessively.

In a modification of the invention, a second control valve is located upstream from the above-referenced control valve, i.e., closer to the hydraulic supply system, at which valve the connection lines of the landing gear actuation device and hydraulic supply lines leading to the first control valve are joined at the outlet side of the control valve. On the inlet side, the second control valve is connectable to the hydraulic supply system. In a first position, the control valve connects the inlet-side hydraulic supply lines through to the first control valve such that, depending on its position, the landing gear actuation device or the door actuation device is able to be actuated. Conversely, in a second position of the second control valve, the landing gear actuation device is connected through, while the above-referenced first control valve along with the landing gear and door actuation devices associated with it are disconnected from the hydraulic supply system. Advantageously here, the first position of the second control valve is the initial position of the second valve. This ensures that in the event of a failure of the control valve, the doors are opened and the landing gear is able to be lowered. It is preferable to sacrifice the steering of the landing gear in favor of being able to lower it.

The first control valve may be in the form of a 10/3 solenoid valve, while the second control valve may be an 8/2 solenoid valve.

In order to enable the landing gear to be lowered even in an emergency situation, i.e., if the hydraulic supply system fails, a third control valve can be provided through which the landing gear actuation device and door actuation device are directly connectable by bypassing the other control valves, wherein in an initial position of the third control valve the connection lines of the landing gear actuation device and door actuation device are simply connected through to the hydraulic supply lines which lead to the above-referenced first control valve. In this initial position, the landing gear actuation device and door actuation device are able to be actuated in the above-outlined manner by the hydraulic supply system. In an emergency, however, the third control valve can be switched over to an emergency position in which the outlet lines of the landing gear actuation device and door actuation device are connected to the inlet line of the door actuation device, while the inlet line of the landing gear actuation device is connected to the system reservoir. In this position, the landing gear can be lowered by gravity. The hydraulic fluid forced out through the outlet line of the landing gear actuation device is forced here into the door actuation device, thereby opening the doors. The hydraulic fluid forced out on the opposite side from the actuating cylinder of the door actuation device is recirculated in a closed loop to the other chamber of the actuating cylinder of the door actuation device, thereby opening the doors as rapidly as possible. In order to prevent the landing gear from not lowering completely because the fluid from the actuating cylinder of the landing gear actuation device is not able to be passed completely into the actuating cylinder of the door actuation device, the outlet line of the landing gear actuation device is additionally connected through a choke to the system reservoir, thereby allowing hydraulic fluid to flow back, as necessary, into the reservoir as well.

Due to the small number of required solenoid valves, the valve system is less susceptible to failures. The front landing gear actuation system is able to function with only three solenoid valves. The main landing gear is even able to function with only two solenoid valves.

The following discussion explains the invention in more detail based on a preferred embodiment and associated drawings.

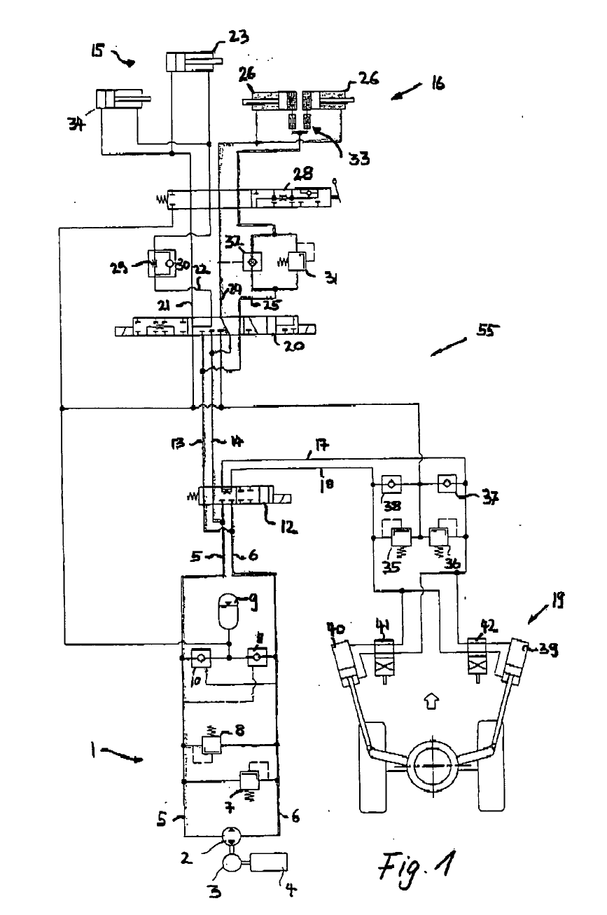

FIG. 1 is a schematic view of a front landing gear actuation system of an aircraft according to a preferred embodiment of the invention shown in a schematic view, wherein the valves are shown in an operating position in which the landing gear doors are actuatable.

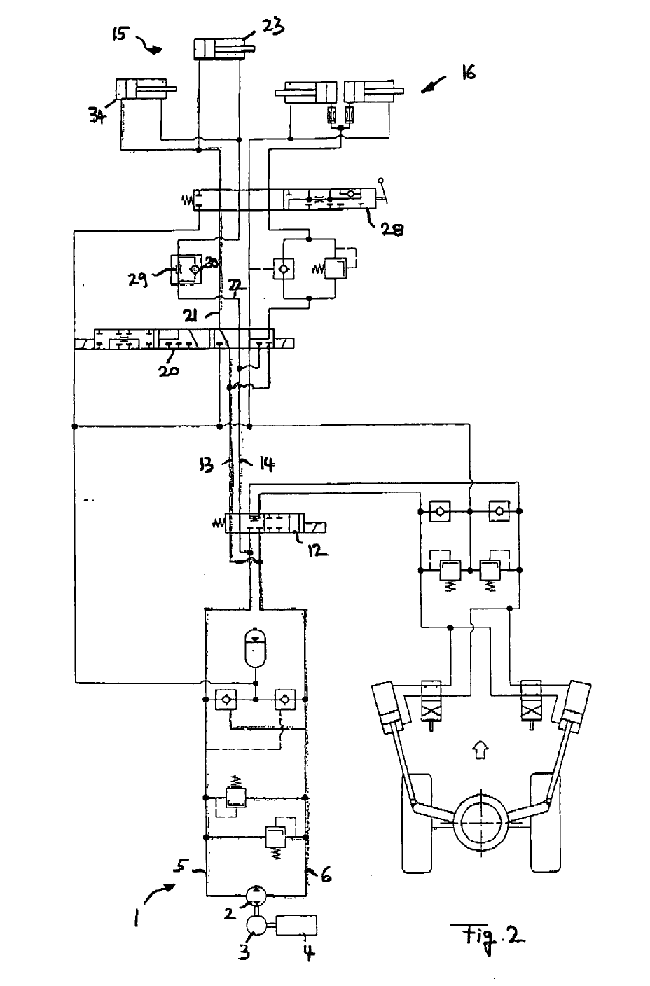

FIG. 2 shows the front landing gear actuation system of FIG. 1, wherein the valves are shown in an operating position in which the landing gear is retractable and lowerable;

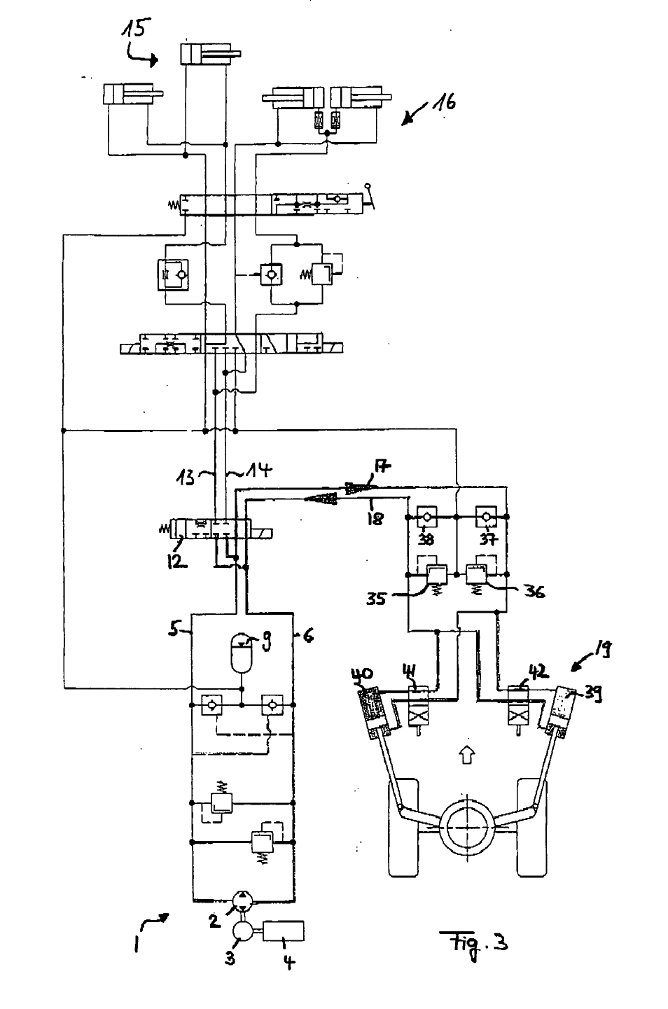

FIG. 3 shows the front landing gear actuation system of the previous figures, wherein the valves are shown in an operating position in which the landing gear steering is actuatable;

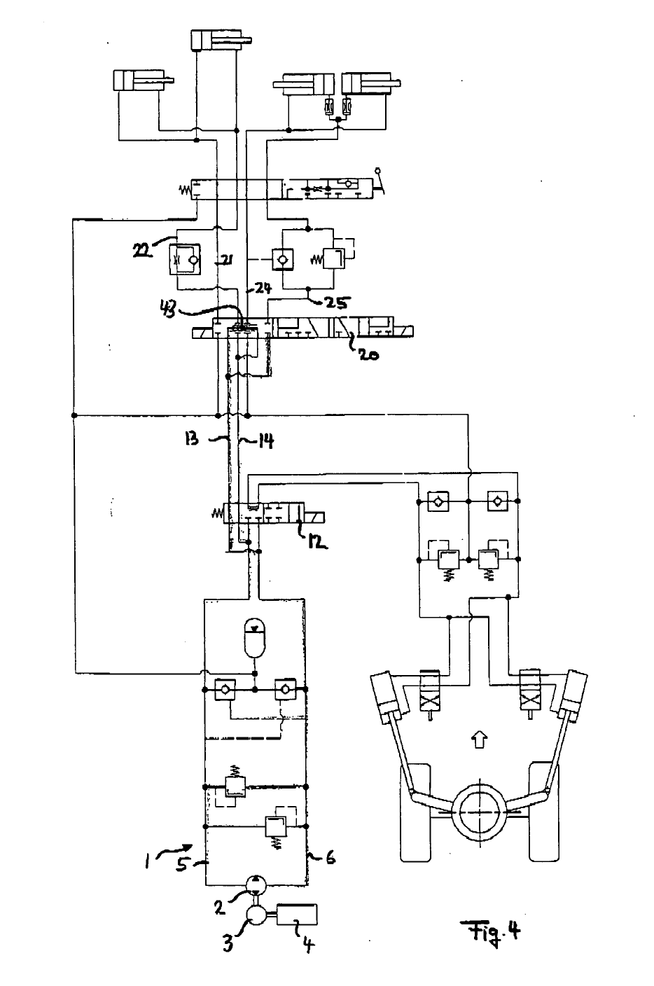

FIG. 4 shows the front landing gear actuation system of the previous figures, wherein the valves are shown in an operating position in which all operating positions are blocked and the hydraulic fluid is able to circulate through a filament choke in order to be heated;

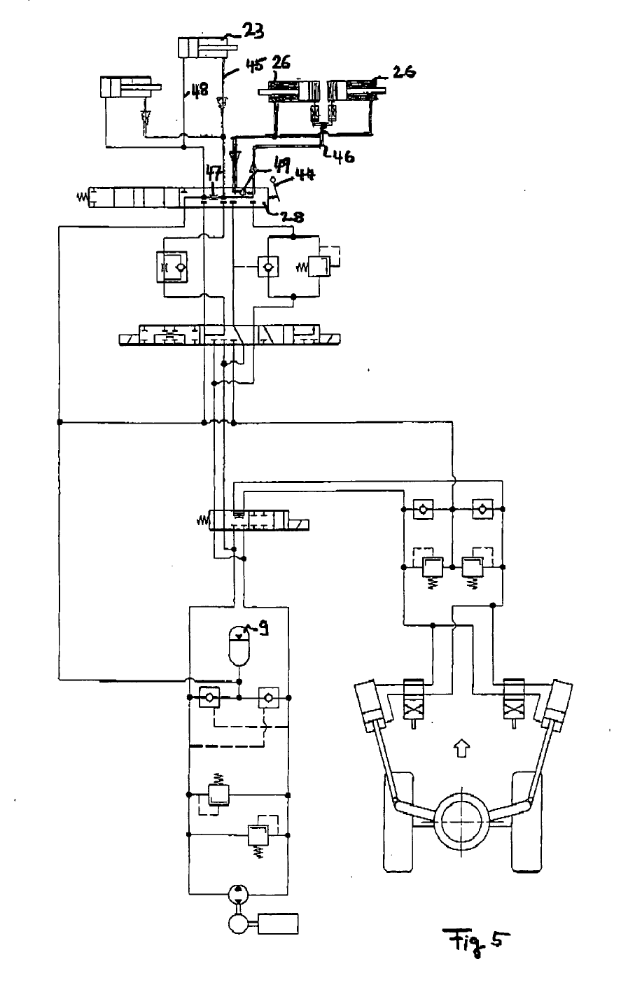

FIG. 5 shows the front landing gear actuation system of the previous figures, wherein the valves are shown in an operating position in which the landing gear is able to be lowered and the landing gear doors are able to be opened in an emergency without externally supplied power; and

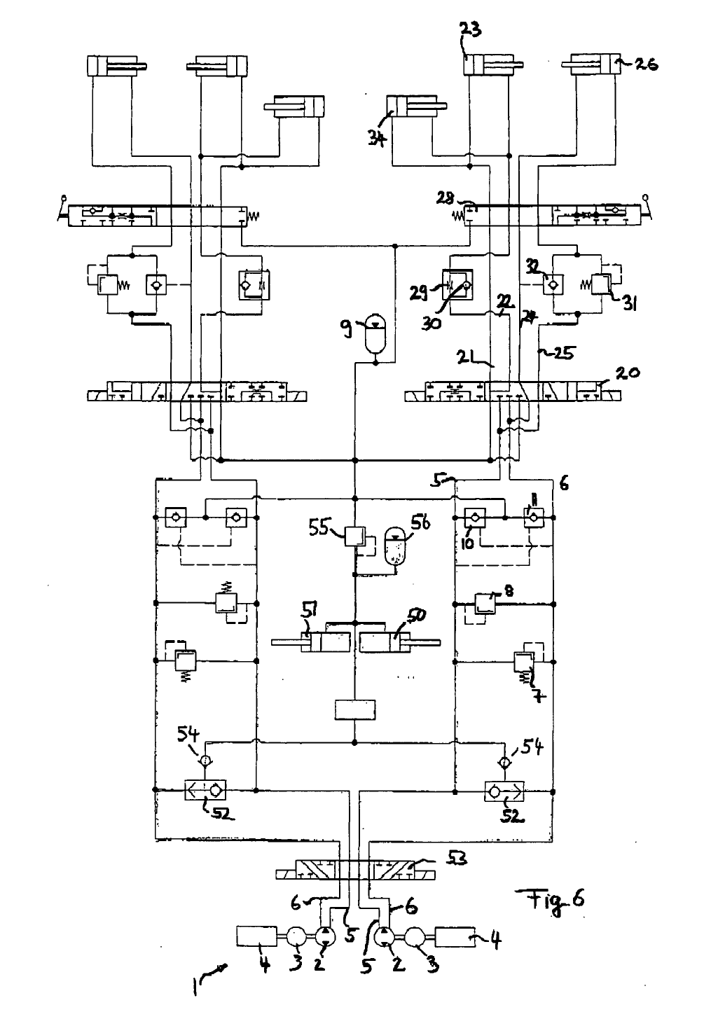

FIG. 6 shows a main landing gear actuation system according to a preferred embodiment, wherein the valves are shown in a position in which the landing gear doors are able to be opened or closed.

The front landing gear actuation system shown in FIGS. 1 through 5 comprises a separate local hydraulic supply system 1 which has a hydraulic pump 2 and an electric motor 3 driving this pump, the motor being controllable by an electronic control device 4. Hydraulic supply system 1 is operated in a closed circuit. The hydraulic supply lines 5 and 6 form a feed line and return line, depending on the rotational direction of the hydraulic pump 2. Hydraulic supply lines 5 and 6 are initially interconnected to pressure relief valves 7 and 8 in order to allow an overflow to the return side in the event of excessive pressure in the feed line. A reservoir 9 is connectable to hydraulic supply lines 5 and 6 through pressure-controlled shutoff valves 10 and 11 which are in the form of so-called pilot check valves.

Hydraulic supply lines 5 and 6 lead first to a control valve 12 in the form of an 8/2 solenoid valve. Connected on the outlet side to control valve 12 are: on the one hand, hydraulic supply lines 13 and 14 which lead to landing gear actuation device 15 in order to retract and lower the landing gear, and to door actuation device 16 to open and close the landing gear doors, and, on the other hand, supply hydraulic supply lines 17 and 18 which supply landing gear steering device 19.

Hydraulic supply lines 13 and 14 for landing gear actuation device 15 and door actuation device 16 lead to another control valve 20 which is in the form of a 10/3 solenoid valve and selectively directs the hydraulic pressure present in hydraulic supply lines 13 and 14 either to landing gear actuation device 15 or door actuation device 16. Connected on the outlet side to control valve 20 are: on the one hand, hydraulic supply lines 21, 22 which lead to the actuating cylinder 23 of landing gear actuation device 15, and, on the other hand, hydraulic supply lines 24 and 25 which lead to actuating cylinders 26 of door actuation device 16. Hydraulic supply lines 21, 22 and 24, 25 extending from control valve 20 are routed through an emergency control valve 28 by means of which the landing gear is able to be lowered and the doors also opened in an emergency without any hydraulic power from hydraulic supply system 1—as will be explained below. As FIG. 1 shows, a choke 29 is connected into hydraulic supply line 22 which returns the hydraulic fluid from associated actuating cylinder 23 when the landing gear is lowered and which is under pressure when the landing gear is retracted, which throttle is able to be bypassed through a nonreturn valve 30 which opens when the landing gear retracts. Connected into hydraulic supply line 25, which is under pressure when the doors open and serves to return the hydraulic fluid from actuating cylinder 26 when the doors are closed, is both a pressure relief valve 31 and parallel controllable shutoff valve 32 which is controlled by the pressure applied in hydraulic supply line 24.

In the operating position of the valves shown in FIG. 1, door actuation device 16 is able to be actuated. If motor 3 is actuated by control device 4 in the correct rotational direction, pressure is generated by hydraulic pump 2 in hydraulic supply line 6. This pressure is connected through by control valve 12, which is in its spring-loaded initial position, to hydraulic supply line 13 which in turn is connected through control valve 20 to hydraulic supply line 25. This line passes the hydraulic fluid through flow dividers 33 into actuating cylinder 26, thereby also enabling these cylinders to open the doors.

When door actuation device 16 is actuated, landing gear steering device 19 is, on the one hand, blocked by control valve 12. On the other hand, landing gear actuation device 15 is also blocked by control valve 20. In this configuration, only actuation of the doors is thus possible.

If after successfully opening the doors the landing gear is to be lowered, the control valves are moved to the position illustrated in FIG. 2. As shown in FIG. 2, control valve 20 is switched to the left position, while the upstream control valve 12 remains fixed in the in initial position. As a result, the hydraulic pressure applied in hydraulic supply lines 13 or 14 is connected through control valve 20 into hydraulic supply lines 21 or 22. To effect lowering, hydraulic pump 2 is operated such that hydraulic supply line 21 is under pressure. The pressure applied in hydraulic supply line 21 first moves actuating cylinder 23 into its lowering position. Secondly, pressure is applied to a lowering lock cylinder 34. The fluid returned through hydraulic supply line 22 is returned through throttle 29. To effect retraction of the landing gear, the rotational direction of motor 3 is reversed so that hydraulic supply line 22 is under pressure. The fluid is able, first of all, to move in actuating cylinder 23 by bypassing throttle 29, and secondly, to move locking cylinder 34 into its unlocking position.

In order to be able steer the landing gear after it has been lowered, control valve 12 is moved into its second position, as shown in FIG. 3, specifically, by the solenoid against the spring bias. In this operating position, hydraulic supply lines 13 and 14, and thus landing gear actuation device 15 and door actuation device 16 are blocked by hydraulic supply system 1. Hydraulic supply lines 17 and 18, on the other hand, are connected through to the hydraulic pressure source which leads to landing gear steering device 19. As FIG. 3 shows, hydraulic supply lines 17 and 18 can be connected on one side to reservoir 9 through pressure relief valves. On the other side, they can be connected through nonreturn valves 37, 38 to reservoir 9, so that additional hydraulic fluid can be drawn, when required, from reservoir 9 in order to prevent bubble formation (cavitation) in the lines in response to low pressure. By appropriately controlling motor 3, the front landing gear can be controlled through actuating cylinders 39, 40 by hydraulic supply system 1. The steering here can be moved beyond the dead center point of the pitman by switchover valves 41, 42.

When no landing gear actuation is to occur, the control valves are moved into the position illustrated in FIG. 4. Control valve 12 is in its initial position, in which hydraulic supply lines 5 and 6 are connected through to hydraulic supply lines 13 and 14. However, hydraulic supply lines 21, 22, and 24, 25 for landing gear and door actuation devices 15 and 16 are blocked by control valve 20. Hydraulic supply lines 13 and 14 are short-circuited in control valve 20, specifically, by a filament choke 43. If the temperature of the hydraulic fluid falls below a predetermined threshold value, motor 3, and thus pump 2 can be started up. The hydraulic fluid circulates through the short-circuit in control valve 20 through filament choke 43 by which an increase in temperature is achieved. No accidental actuation of the various actuation devices is possible during this time.

If one of the hydraulic supply system components fails, for example, the entire hydraulic supply system 1, then emergency control valve 28 can be shifted from its initial position to its second operating position, as shown in FIG. 5. Emergency control valve 28 is in the form of a 10/2 solenoid valve. If necessary, a manual actuation connection for the cockpit crew can be added so as not to be dependent on the electrically actuated actuating forces of the solenoid. FIG. 5 shows a manual actuating lever 44. In this emergency position of FIG. 5, landing gear actuation device 15 and door actuation device 16 are directly linked, specifically, bypassing the other control valves. Hydraulic line 45, which is connected to the piston-rod-side chamber of actuating cylinder 23, is connected through valve 28 to the inlet line 46 of actuating cylinder 26 of door actuation device 16. In addition, hydraulic line 45 is connected through throttle 47 in valve 28 to reservoir 9. Also connected to reservoir 9 is hydraulic line 48 which is connected to the second chamber of actuating cylinder 23. In the case of actuating cylinder 26 of door actuation device 16, the piston-rod-side actuating cylinder chamber is short-circuited through nonreturn valve 49 to inlet line 46. The resulting function is as follows: the landing gear is pressed down by gravity. As a result, the hydraulic fluid forced into hydraulic line 45 is forced through valve 28 and inlet-side hydraulic line 46 into actuating cylinder 26, thereby pushing open the landing gear doors. At the same time, hydraulic fluid is able to flow from reservoir 9 into the second chamber of actuating cylinder 23. In order to accelerate the opening of the doors, the hydraulic fluid forced out of actuating cylinder 26 is not returned to the reservoir but recirculated into inlet-side hydraulic line 46. After the landing gear doors have opened completely, the excess hydraulic fluid can be passed through throttle 47 into reservoir 9.

The landing gear actuation system shown in FIG. 6 for actuating the right and left main landing gear is in large part identical to the front landing gear actuation system described above, and thus the same reference numbers are used for corresponding components. Missing are only the landing gear steering device 19 and associated control valve 12. In the event the main landing gears are each to be provided with a pitch trimmer which uses two actuating cylinders 50 and 51 to force a so-called bogie landing gear into its ground-clearance-increasing position, the pitch trimmers can be continuously supplied using the circuit shown. As FIG. 6 shows, actuating cylinders 50 and 51 are always pretensioned in their ground-clearance-increasing position independently of the operating position of control valve 20. They are always connected through a so-called shuttle valve 52 to the respective pressure-conducting hydraulic supply lines 5 and 6. The nonreturn valves 54 along with a pressure relief valve 55 ensure that the supplied pressure is maintained. If the pressure rises above a predefined level, the pressure relief valve will open and deliver the excess hydraulic fluid to reservoir 9.

As FIG. 6 shows, the landing gear actuation systems for the right and left landing gear are each equipped with separate hydraulic supply systems, each having separate motors 3 and separate hydraulic pumps 2. To enhance safety, it is possible to use hydraulic supply system 1 of the right landing gear to actuate the left landing gear, and visa versa, through a switchover valve 53, which is connected into each of hydraulic supply lines 5 and 6, and is in the form of a 8/3 solenoid valve—thereby achieving a redundant design. If required, it is also possible to provide only one common hydraulic supply system 1 for both main landing gears. Otherwise the configuration of control valves 20 and emergency actuation valves 28 corresponds to the configuration in the front landing gear which was described in detail in connection with FIGS. 1 through 5, which are hereby referenced.

1. Aircraft landing gear actuation system, comprising a door actuation device (16) to open and close a landing gear door, and a landing gear actuation device (15) to retract and lower the landing gear, characterized in that at least the landing gear actuation device (15) has an electric actuator motor (3).

2. Aircraft landing gear actuation system according to claim 1, wherein the landing gear actuation device (15), the door actuation device (16), and a possibly provided landing gear steering device (19) are of an electrohydraulic design, wherein the electric actuator motor (3) drives a hydraulic pump (2) by which the actuating cylinders (23, 26, 39, 40) of the landing gear actuation device (15), of the door actuation device (16), and of the possibly provided landing gear steering device (19) are able to be actuated.

3. Aircraft landing gear actuation system according to claim 1, wherein the electric actuator motor (3) is provided exclusively for the purpose of landing gear actuation.

4. Aircraft landing gear actuation system according to claim 1, wherein the front landing gear and main landing gear have separate electric actuator motors (3) and/or separate hydraulic pumps (2).

5. Aircraft landing gear actuation system according to claim 1, wherein a control device (4) is provided which controls the actuation of the landing gear actuation device (15), of the door actuation device (16), and/or of the landing gear steering device (19), by controlling the speed and direction of rotation of the actuator motor (3) and of the hydraulic pump driven thereby.

6. Aircraft landing gear actuation system according to claim 1, wherein a control device (4) is provided which controls the actuation of the landing gear actuation device (15), door actuation device (16), and/or landing gear steering device (19), using an actuator motor (3) running at an essentially constant rate and hydraulic pump (2) running at an essentially constant rate, whereby said control device controls the delivery volume using, for example, a flow control valve.

7. Aircraft landing gear actuation system according to claim 1, wherein the door actuation device, landing gear actuation device, and possible landing gear steering device can be connected through a valve system (55) to the same hydraulic supply source (2), wherein the valve system (55) is designed such that at all times at maximum of only one actuation device (15, 16, 19) can be connected to the hydraulic supply source (2).

8. Aircraft landing gear actuation system according to claim 1, wherein the valve system (55) is composed of control valves (12, 20) connected in series which on the outlet side always open only one outlet channel or outlet channel pair composed of a forward and return line.

9. Aircraft landing gear actuation system according to claim 1, wherein the connection lines (21, 22; 24, 25) of the landing gear actuation device (15) and door actuation device (16) are joined at a common control valve (20) which is connectable on the inlet side with the hydraulic supply system (2); which connects, in a first position, the connection lines (21, 22) of the landing gear actuation device (15) to the main hydraulic supply system (2) while simultaneously interrupting the connection lines (24, 25) of the door actuation device (16) from the hydraulic supply system (2); and which connects, in a second position, the connection lines (24, 25) of the door actuation device (16) to the hydraulic supply system (2), and simultaneously interrupts the connection lines (21, 22) of the landing gear actuation device (15) from the hydraulic supply system (2).

10. Aircraft landing gear actuation system according to claim 1, wherein the control valve (20) has a third position in which the connection lines (21, 22; 24, 25) of both the landing gear actuation device (15) and door actuation device (16) are disconnected from the hydraulic supply system (2), and the inlet-side-connected lines (13, 14) of the hydraulic supply system (2) are short-circuited, preferably, by being routed through a filament choke (43).

11. Aircraft landing gear actuation system according to claim 1, wherein the control valve (20) is in the form of a 10/3 solenoid valve.

12. Aircraft landing gear actuation system according to claim 1, wherein the connection lines (17, 18) of the landing gear steering device (19), and the connection lines (13, 14) for the landing gear actuation device (15) and door actuation device (16), are joined at the outlet side of the control valve (12) which is connectable on the inlet side to the hydraulic supply system (2), said valve connecting, in a first position, the connection lines (13, 14) for the landing gear actuation device (15) and door actuation device (16) to the hydraulic supply system (2) while simultaneously disconnecting the connection lines (17, 18) of the landing gear steering device (19) from the hydraulic supply system; and said valve, in a second position, disconnecting the connection lines (13,14) for the landing gear actuation device (15) and door actuation device (16) from the hydraulic supply system (2) while simultaneously connecting the connection lines (17, 18) of the landing gear steering device (19) to the hydraulic supply system (2).

13. Aircraft landing gear actuation system according to claim 1, wherein the first position is the initial position of the control valve (12).

14. Aircraft landing gear actuation system according to claim 12, wherein the control valve (12) is provided as an 8/2 solenoid valve.

15. Aircraft landing gear actuation system according to claim 1, wherein the landing gear actuation device (15) and door actuation device (16) are directly connectable through a control valve (28) which, in an initial position, connects the connection lines of the landing gear actuation device (15) and door actuation device (16) to the hydraulic supply lines (21, 22; 24, 25); and, in an emergency position, connects the outlet line (45) of the landing gear actuation device (15) and outlet line of the door actuation device (16) to the inlet line (46) of the door actuation device (16), and connects the inlet line (48) of the landing gear actuation device (15) to the system reservoir (9).

16. Aircraft landing gear actuation system according to claim 1, wherein the valve system (55) of the front landing gear has exactly three control valves (12, 20, 28) actuatable by external power, and/or the valve system of each landing gear has exactly two control valves (20, 28) actuatable by external power.

17. Aircraft landing gear actuation system according to claim 13, wherein the control valve (12) is provided as an 8/2 solenoid valve.

18. Aircraft landing gear actuation system according to claim 2, wherein the connection lines (21, 22; 24, 25) of the landing gear actuation device (15) and door actuation device (16) are joined at a common control valve (20) which is connectable on the inlet side with the hydraulic supply system (2); which connects, in a first position, the connection lines (21, 22) of the landing gear actuation device (15) to the main hydraulic supply system (2) while simultaneously interrupting the connection lines (24, 25) of the door actuation device (16) from the hydraulic supply system (2); and which connects, in a second position, the connection lines (24, 25) of the door actuation device (16) to the hydraulic supply system (2), and simultaneously interrupts the connection lines (21, 22) of the landing gear actuation device (15) from the hydraulic supply system (2).

19. Aircraft landing gear actuation system according to claim 5, wherein the connection lines (21, 22; 24, 25) of the landing gear actuation device (15) and door actuation device (16) are joined at a common control valve (20) which is connectable on the inlet side with the hydraulic supply system (2); which connects, in a first position, the connection lines (21, 22) of the landing gear actuation device (15) to the main hydraulic supply system (2) while simultaneously interrupting the connection lines (24, 25) of the door actuation device (16) from the hydraulic supply system (2); and which connects, in a second position, the connection lines (24, 25) of the door actuation device (16) to the hydraulic supply system (2), and simultaneously interrupts the connection lines (21, 22) of the landing gear actuation device (15) from the hydraulic supply system (2).

20. Aircraft landing gear actuation system according to claim 6, wherein the connection lines (21, 22; 24, 25) of the landing gear actuation device (15) and door actuation device (16) are joined at a common control valve (20) which is connectable on the inlet side with the hydraulic supply system (2); which connects, in a first position, the connection lines (21, 22) of the landing gear actuation device (15) to the main hydraulic supply system (2) while simultaneously interrupting the connection lines (24, 25) of the door actuation device (16) from the hydraulic supply system (2); and which connects, in a second position, the connection lines (24, 25) of the door actuation device (16) to the hydraulic supply system (2), and simultaneously interrupts the connection lines (21, 22) of the landing gear actuation device (15) from the hydraulic supply system (2).
